(19) United States
(12) Patent Application Publication
(10) Pub. No.: US 2024/0201309 A1
(43) Pub. Date: Jun. 20, 2024

(54) LOCATION ASSISTANCE DATA ASSOCIATED WITH AERIAL USER EQUIPMENT

(71) Applicant: QUALCOMM Incorporated, San Diego, CA (US)

(72) Inventors: Alberto RICO ALVARINO, San Diego, CA (US); Alexandros MANOLAKOS, Escondido, CA (US); Chiranjib SAHA, Lakeside, CA (US); Le LIU, San Jose, CA (US); Kazuki TAKEDA, Tokyo (JP); Umesh PHUYAL, San Diego, CA (US)

(21) Appl. No.: 18/555,076

(22) PCT Filed: Apr. 1, 2022
(86) PCT No.: PCT/US2022/071499

§ 371 Date: Oct. 12, 2023

(30) Foreign Application Priority Data
May 24, 2021 (GR) 20210100340

(51) Int. Cl. G01S 5/02; H04W 8/24; H04W 64/00; H04W 84/06

(52) U.S. Cl. CPC G01S 5/0236; H04W 8/24; H04W 64/006; G01S 2205/03; H04W 84/06

(57) ABSTRACT

Disclosed are techniques for wireless communication. In an aspect, a UE transmits, to a location server (e.g., a location management function (LMF)), a message comprising information that is based on the UE being configured as an aerial UE that is capable of flight. The location server selects assistance data based in part upon the information in the message, and transmits the assistance data to the UE.

### CROSS-REFERENCE TO RELATED APPLICATIONS

The present application for patent claims the benefit of GR Application No. 20210100340, entitled LOCATION ASSISTANCE DATA ASSOCIATED WITH AERIAL USER EQUIPMENT”, filed May 24, 2021, and is a national stage application, filed under 35 U.S.C. § 371, of International Patent Application No. PCT/US2022/071499, entitled, “LOCATION ASSISTANCE DATA ASSOCIATED WITH AERIAL USER EQUIPMENT”, filed Apr. 1, 2022, both of which are assigned to the assignee hereof and are expressly incorporated herein by reference in their entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of operating a user equipment (UE) includes transmitting, to a location server, a message comprising information that is based on the UE being configured as an aerial UE that is capable of flight, and receiving, from the location server, assistance data that is based in part upon the information in the message.

In some aspects, the method includes receiving a capability request from the location server, wherein the message is transmitted in response to the capability request.

In some aspects, the message corresponds to a request for the assistance data.

In some aspects, the message corresponds to a capability indication.

In some aspects, the information indicates that the UE is configured as the aerial UE.

In some aspects, the information indicates whether the UE is engaged in a flying state or a ground state.

In some aspects, the information indicates that the UE is engaged in the flying state, and the information further indicates a height or altitude of the UE.

In some aspects, the information comprises flight path information.

In some aspects, the flight path information comprises a sequence of waypoints and associated time stamps.

In some aspects, the sequence of waypoints corresponds to a sequence of points, coordinates, polygons, or ellipsoids.

In some aspects, the flight path information comprises a trajectory and velocity of the UE.

In some aspects, the assistance data comprises information associated with one or more beams from one or more base stations that are angled upwards to facilitate communication with in-flight aerial UEs.

In some aspects, the assistance data comprises information associated with one or more base stations that are remote from the UE, with one or more other intervening base stations that are closer to the UE being omitted from the assistance data.

In some aspects, the network entity comprises a location management function (LMF).

In an aspect, a method of operating a location server includes receiving, from a user equipment (UE), a message comprising information that is based on the UE being configured as an aerial UE that is capable of flight; selecting assistance data based in part upon the information in the message; and transmitting the assistance data to the UE.

In some aspects, the method includes transmitting a capability request to the UE, wherein the message is received in response to the capability request.

In some aspects, the message corresponds to a request for the assistance data.

In some aspects, the message corresponds to a capability indication.

In some aspects, the information indicates that the UE is configured as the aerial UE.

In some aspects, the information indicates whether the UE is engaged in a flying state or a ground state.

In some aspects, the information indicates that the UE is engaged in the flying state, and the information further indicates a height or altitude of the UE.

In some aspects, the information comprises flight path information.

In some aspects, the flight path information comprises a sequence of waypoints and associated time stamps.

In some aspects, the sequence of waypoints corresponds to a sequence of points, coordinates, polygons, or ellipsoids.

In some aspects, the flight path information comprises a trajectory and velocity of the UE.

In some aspects, the assistance data comprises information associated with one or more beams from one or more base stations that are angled upwards to facilitate communication with in-flight aerial UEs.

In some aspects, the assistance data comprises information associated with one or more base stations that are remote from the UE, with one or more other intervening base stations that are closer to the UE being omitted from the assistance data.

In some aspects, the network entity comprises a location management function (LMF).

In an aspect, a user equipment (UE) includes a memory; at least one transceiver; and at least one processor communicatively coupled to the memory and the at least one transceiver, the at least one processor configured to: transmit, via the at least one transceiver, to a location server, a message comprising information that is based on the UE being configured as an aerial UE that is capable of flight; and receive, via the at least one transceiver, from the location server, assistance data that is based in part upon the information in the message.

In some aspects, the at least one processor is further configured to: receive, via the at least one transceiver, a capability request from the location server, wherein the message is transmitted in response to the capability request.

In some aspects, the message corresponds to a request for the assistance data.

In some aspects, the message corresponds to a capability indication.

In some aspects, the information indicates that the UE is configured as the aerial UE.

In some aspects, the information indicates whether the UE is engaged in a flying state or a ground state.

In some aspects, the information indicates that the UE is engaged in the flying state, and the information further indicates a height or altitude of the UE.

In some aspects, the information comprises flight path information.

In some aspects, the flight path information comprises a sequence of waypoints and associated time stamps.

In some aspects, the sequence of waypoints corresponds to a sequence of points, coordinates, polygons, or ellipsoids.

In some aspects, the flight path information comprises a trajectory and velocity of the UE.

In some aspects, the assistance data comprises information associated with one or more beams from one or more base stations that are angled upwards to facilitate communication with in-flight aerial UEs.

In some aspects, the assistance data comprises information associated with one or more base stations that are remote from the UE, with one or more other intervening base stations that are closer to the UE being omitted from the assistance data.

In some aspects, the network entity comprises a location management function (LMF).

In an aspect, a location server includes a memory, at least one transceiver; and at least one processor communicatively coupled to the memory and the at least one transceiver, the at least one processor configured to: receive, via the at least one transceiver, from a user equipment (UE), a message comprising information that is based on the UE being configured as an aerial UE that is capable of flight; select assistance data based in part upon the information in the message; and transmit, via the at least one transceiver, the assistance data to the UE.

In some aspects, the at least one processor is further configured to: transmit, via the at least one transceiver, a capability request to the UE, wherein the message is received in response to the capability request.

In some aspects, the message corresponds to a request for the assistance data.

In some aspects, the message corresponds to a capability indication.

In some aspects, the information indicates that the UE is configured as the aerial UE.

In some aspects, the information indicates whether the UE is engaged in a flying state or a ground state.

In some aspects, the information indicates that the UE is engaged in the flying state, and the information further indicates a height or altitude of the UE.

In some aspects, the information comprises flight path information.

In some aspects, the flight path information comprises a sequence of waypoints and associated time stamps.

In some aspects, the sequence of waypoints corresponds to a sequence of points, coordinates, polygons, or ellipsoids.

In some aspects, the flight path information comprises a trajectory and velocity of the UE.

In some aspects, the assistance data comprises information associated with one or more beams from one or more base stations that are angled upwards to facilitate communication with in-flight aerial UEs.

In some aspects, the assistance data comprises information associated with one or more base stations that are remote from the UE, with one or more other intervening base stations that are closer to the UE being omitted from the assistance data.

In some aspects, the network entity comprises a location management function (LMF).

In an aspect, a user equipment (UE) includes means for transmitting, to a location server, a message comprising information that is based on the UE being configured as an aerial UE that is capable of flight; and means for receiving, from the location server, assistance data that is based in part upon the information in the message.

In some aspects, the method includes means for receiving a capability request from the location server, wherein the message is transmitted in response to the capability request.

In some aspects, the message corresponds to a request for the assistance data.

In some aspects, the message corresponds to a capability indication.

In some aspects, the information indicates that the UE is configured as the aerial UE.

In some aspects, the information indicates whether the UE is engaged in a flying state or a ground state.

In some aspects, the information indicates that the UE is engaged in the flying state, and the information further indicates a height or altitude of the UE.

In some aspects, the information comprises flight path information.

In some aspects, the flight path information comprises a sequence of waypoints and associated time stamps.

In some aspects, the sequence of waypoints corresponds to a sequence of points, coordinates, polygons, or ellipsoids.

In some aspects, the flight path information comprises a trajectory and velocity of the UE.

In some aspects, the assistance data comprises information associated with one or more beams from one or more base stations that are angled upwards to facilitate communication with in-flight aerial UEs.

In some aspects, the assistance data comprises information associated with one or more base stations that are remote from the UE, with one or more other intervening base stations that are closer to the UE being omitted from the assistance data.

In some aspects, the network entity comprises a location management function (LMF).

In an aspect, a location server includes means for receiving, from a user equipment (UE), a message comprising information that is based on the UE being configured as an aerial UE that is capable of flight; means for selecting assistance data based in part upon the information in the message; and means for transmitting the assistance data to the UE.

In some aspects, the method includes means for transmitting a capability request to the UE, wherein the message is received in response to the capability request.

In some aspects, the message corresponds to a request for the assistance data.

In some aspects, the message corresponds to a capability indication.

In some aspects, the information indicates that the UE is configured as the aerial UE.

In some aspects, the information indicates whether the UE is engaged in a flying state or a ground state.

In some aspects, the information indicates that the UE is engaged in the flying state, and the information further indicates a height or altitude of the UE.

In some aspects, the information comprises flight path information.

In some aspects, the flight path information comprises a sequence of waypoints and associated time stamps.

In some aspects, the sequence of waypoints corresponds to a sequence of points, coordinates, polygons, or ellipsoids.

In some aspects, the flight path information comprises a trajectory and velocity of the UE.

In some aspects, the assistance data comprises information associated with one or more beams from one or more base stations that are angled upwards to facilitate communication with in-flight aerial UEs.

In some aspects, the assistance data comprises information associated with one or more base stations that are remote from the UE, with one or more other intervening base stations that are closer to the UE being omitted from the assistance data.

In some aspects, the network entity comprises a location management function (LMF).

In an aspect, a non-transitory computer-readable medium storing computer-executable instructions that, when executed by a user equipment (UE), cause the UE to: transmit, to a location server, a message comprising information that is based on the UE being configured as an aerial UE that is capable of flight; and receive, from the location server, assistance data that is based in part upon the information in the message.

In some aspects, the one or more instructions further cause the UE to: receive a capability request from the location server, wherein the message is transmitted in response to the capability request.

In some aspects, the message corresponds to a request for the assistance data.

In some aspects, the message corresponds to a capability indication.

In some aspects, the information indicates that the UE is configured as the aerial UE.

In some aspects, the information indicates whether the UE is engaged in a flying state or a ground state.

In some aspects, the information indicates that the UE is engaged in the flying state, and the information further indicates a height or altitude of the UE.

In some aspects, the information comprises flight path information.

In some aspects, the flight path information comprises a sequence of waypoints and associated time stamps.

In some aspects, the sequence of waypoints corresponds to a sequence of points, coordinates, polygons, or ellipsoids.

In some aspects, the flight path information comprises a trajectory and velocity of the UE.

In some aspects, the assistance data comprises information associated with one or more beams from one or more base stations that are angled upwards to facilitate communication with in-flight aerial UEs.

In some aspects, the assistance data comprises information associated with one or more base stations that are remote from the UE, with one or more other intervening base stations that are closer to the UE being omitted from the assistance data.

In some aspects, the network entity comprises a location management function (LMF).

In an aspect, a non-transitory computer-readable medium storing computer-executable instructions that, when executed by a location server, cause the location server to: receive, from a user equipment (UE), a message comprising information that is based on the UE being configured as an aerial UE that is capable of flight; select assistance data based in part upon the information in the message; and transmit the assistance data to the UE.

In some aspects, the one or more instructions further cause the location server to: transmit a capability request to the UE, wherein the message is received in response to the capability request.

In some aspects, the message corresponds to a request for the assistance data.

In some aspects, the message corresponds to a capability indication.

In some aspects, the information indicates that the UE is configured as the aerial UE.

In some aspects, the information indicates whether the UE is engaged in a flying state or a ground state.

In some aspects, the information indicates that the UE is engaged in the flying state, and the information further indicates a height or altitude of the UE.

In some aspects, the information comprises flight path information.

In some aspects, the flight path information comprises a sequence of waypoints and associated time stamps.

In some aspects, the sequence of waypoints corresponds to a sequence of points, coordinates, polygons, or ellipsoids.

In some aspects, the flight path information comprises a trajectory and velocity of the UE.

In some aspects, the assistance data comprises information associated with one or more beams from one or more base stations that are angled upwards to facilitate communication with in-flight aerial UEs.

In some aspects, the assistance data comprises information associated with one or more base stations that are remote from the UE, with one or more other intervening base stations that are closer to the UE being omitted from the assistance data.

In some aspects, the network entity comprises a location management function (LMF).

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 illustrates a channel model 400 for UAVs in accordance with an aspect of the disclosure. In

FIGS. 5-6 illustrate example methods of communication, according to aspects of the disclosure.

FIG. 7 illustrates an example implementation of the processes of FIGS. 5-6 in accordance with an aspect of the disclosure.

FIG. 8 illustrates an example implementation of the processes of FIGS. 5-6 in accordance with an aspect of the disclosure.

FIG. 9 illustrates a communications system in accordance with an aspect of the disclosure.

FIG. 10 illustrates a communications system in accordance with an aspect of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

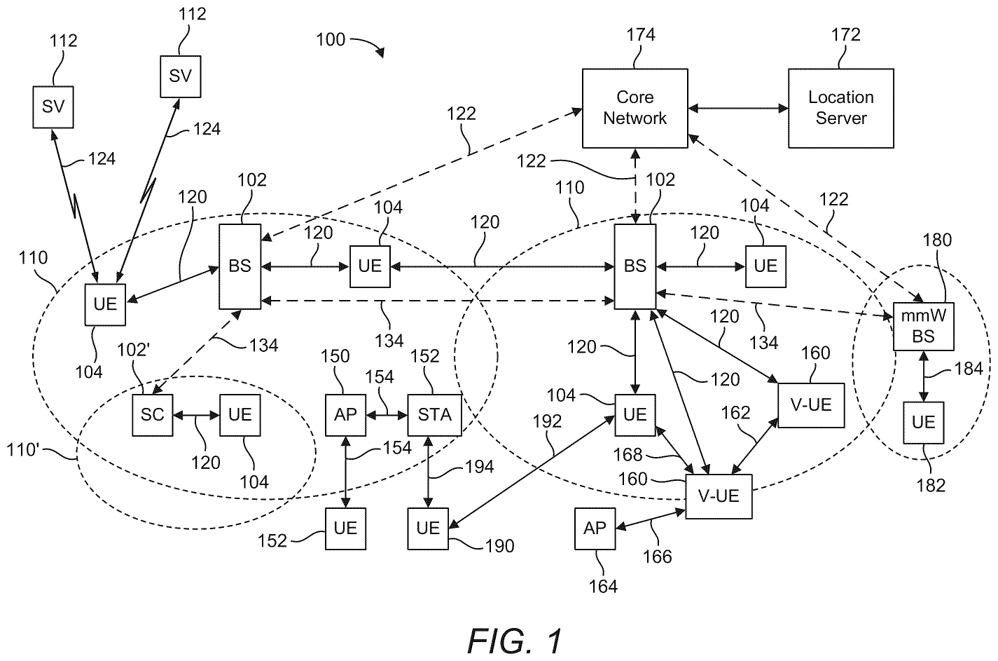

FIG. 1 illustrates an example wireless communications system 100, according to aspects of the disclosure. The wireless communications system 100 (which may also be referred to as a wireless wide area network (WWAN)) may include various base stations 102 (labelled “BS”) and various UEs 104. The base stations 102 may include macro cell base stations (high power cellular base stations) and/or small cell base stations (low power cellular base stations). In an aspect, the macro cell base stations 102 may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 174 (e.g., an evolved packet core (EPC) or 5G core (5GC)) through backhaul links 122, and through the core network 174 to one or more location servers 172 (e.g., a location management function (LMF) or a secure user plane location (SUPL) location platform (SLP)). The location server(s) 172 may be part of core network 174 or may be external to core network 174. In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both the logical communication entity and the base station that supports it, depending on the context. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labelled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a mmW base station 180 that may operate in millimeter wave (mmW) frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

In 5G, the frequency spectrum in which wireless nodes (e.g., base stations 102/180, UEs 104/182) operate is divided into multiple frequency ranges, FR1 (from 450 to 6000 MHz), FR2 (from 24250 to 52600 MHz), FR3 (above 52600 MHz), and FR4 (between FR1 and FR2), mmW frequency bands generally include the FR2, FR3, and FR4 frequency ranges. As such, the terms “mmW” and “FR2” or “FR3” or “FR4” may generally be used interchangeably.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

Leveraging the increased data rates and decreased latency of NR, among other things, vehicle-to-everything (V2X) communication technologies are being implemented to support intelligent transportation systems (ITS) applications, such as wireless communications between vehicles (vehicle-to-vehicle (V2V)), between vehicles and the roadside infrastructure (vehicle-to-infrastructure (V2I)), and between vehicles and pedestrians (vehicle-to-pedestrian (V2P)). The goal is for vehicles to be able to sense the environment around them and communicate that information to other vehicles, infrastructure, and personal mobile devices. Such vehicle communication will enable safety, mobility, and environmental advancements that current technologies are unable to provide. Once fully implemented, the technology is expected to reduce unimpaired vehicle crashes by 80%.

Still referring to FIG. 1, the wireless communications system 100 may include multiple V-UEs 160 that may communicate with base stations 102 over communication links 120 (e.g., using the Uu interface). V-UEs 160 may also communicate directly with each other over a wireless sidelink 162, with a roadside access point 164 (also referred to as a “roadside unit”) over a wireless sidelink 166, or with UEs 104 over a wireless sidelink 168. A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, V2V communication, V2X communication (e.g., cellular V2X (cV2X) communication, enhanced V2X (eV2X) communication, etc.), emergency rescue applications, etc. One or more of a group of V-UEs 160 utilizing sidelink communications may be within the geographic coverage area 110 of a base station 102. Other V-UEs 160 in such a group may be outside the geographic coverage area 110 of a base station 102 or be otherwise unable to receive transmissions from a base station 102. In some cases, groups of V-UEs 160 communicating via sidelink communications may utilize a one-to-many (1:M) system in which each V-UE 160 transmits to every other V-UE 160 in the group. In some cases, a base station 102 facilitates the scheduling of resources for sidelink communications. In other cases, sidelink communications are carried out between V-UEs 160 without the involvement of a base station 102.

In an aspect, the sidelinks 162, 166, 168 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs.

In an aspect, the sidelinks 162, 166, 168 may be cV2X links. A first generation of cV2X has been standardized in LTE, and the next generation is expected to be defined in NR, cV2X is a cellular technology that also enables device-to-device communications. In the U.S. and Europe, cV2X is expected to operate in the licensed ITS band in sub-6 GHz. Other bands may be allocated in other countries. Thus, as a particular example, the medium of interest utilized by sidelinks 162, 166, 168 may correspond to at least a portion of the licensed ITS frequency band of sub-6 GHz. However, the present disclosure is not limited to this frequency band or cellular technology.

In an aspect, the sidelinks 162, 166, 168 may be dedicated short-range communications (DSRC) links. DSRC is a one-way or two-way short-range to medium-range wireless communication protocol that uses the wireless access for vehicular environments (WAVE) protocol, also known as IEEE 802.11p, for V2V. V2I, and V2P communications. IEEE 802.11p is an approved amendment to the IEEE 802.11 standard and operates in the licensed ITS band of 5.9 GHz (5.85-5.925 GHz) in the U.S. In Europe, IEEE 802.11 p operates in the ITS G5A band (5.875-5.905 MHz). Other bands may be allocated in other countries. The V2V communications briefly described above occur on the Safety Channel, which in the U.S. is typically a 10 MHz channel that is dedicated to the purpose of safety. The remainder of the DSRC band (the total bandwidth is 75 MHz) is intended for other services of interest to drivers, such as road rules, tolling, parking automation, etc. Thus, as a particular example, the mediums of interest utilized by sidelinks 162, 166, 168 may correspond to at least a portion of the licensed ITS frequency band of 5.9 GHz.

Alternatively, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Communications between the V-UEs 160 are referred to as V2V communications, communications between the V-UEs 160 and the one or more roadside access points 164 are referred to as V2I communications, and communications between the V-UEs 160 and one or more UEs 104 (where the UEs 104 are P-UEs) are referred to as V2P communications. The V2V communications between V-UEs 160 may include, for example, information about the position, speed, acceleration, heading, and other vehicle data of the V-UEs 160. The V2I information received at a V-UE 160 from the one or more roadside access points 164 may include, for example, road rules, parking automation information, etc. The V2P communications between a V-UE 160 and a UE 104 may include information about, for example, the position, speed, acceleration, and heading of the V-UE 160 and the position, speed (e.g., where the UE 104 is carried by a user on a bicycle), and heading of the UE 104.

Note that although FIG. 1 only illustrates two of the UEs as V-UEs (V-UEs 160), any of the illustrated UEs (e.g., UEs 104, 152, 182, 190) may be V-UEs. In addition, while only the V-UEs 160 and a single UE 104 have been illustrated as being connected over a sidelink, any of the UEs illustrated in FIG. 1, whether V-UEs, P-UEs, etc., may be capable of sidelink communication. Further, although only UE 182 was described as being capable of beam forming, any of the illustrated UEs, including V-UEs 160, may be capable of beam forming. Where V-UEs 160 are capable of beam forming, they may beam form towards each other (i.e., towards other V-UEs 160), towards roadside access points 164, towards other UEs (e.g., UEs 104, 152, 182, 190), etc. Thus, in some cases, V-UEs 160 may utilize beamforming over sidelinks 162, 166, and 168.

The wireless communications system 100 may further include one or more UEs, such as UE 190, that connects indirectly to one or more communication networks via one or more device-to-device (D2D) peer-to-peer (P2P) links. In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on. As another example, the D2D P2P links 192 and 194 may be sidelinks, as described above with reference to sidelinks 162, 166, and 168.

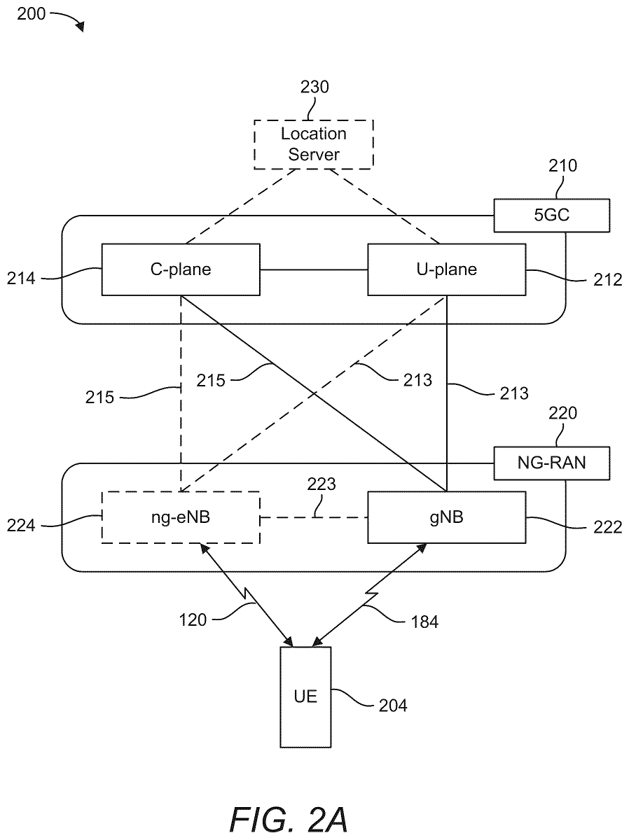

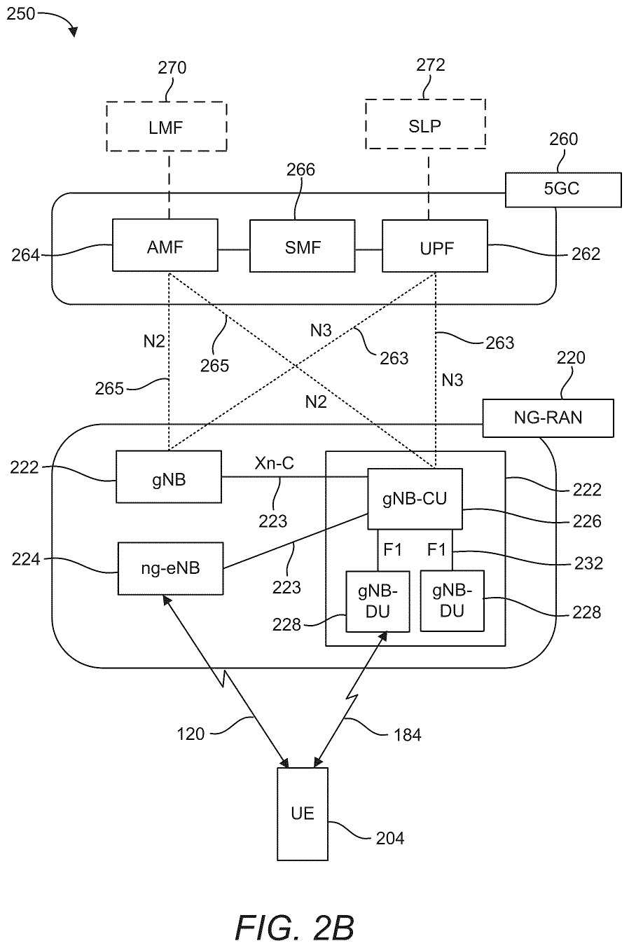

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 250. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (not shown in FIG. 2B) over a user plane (e.g., using protocols intended to carry voice and/or data like the transmission control protocol (TCP) and/or IP).

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 is divided between a gNB central unit (gNB-CU) 226 and one or more gNB distributed units (gNB-DUs) 228. The interface 232 between the gNB-CU 226 and the one or more gNB-DUs 228 is referred to as the “F1” interface. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 hosts the radio resource control (RRC), service data adaptation protocol (SDAP), and packet data convergence protocol (PDCP) protocols of the gNB 222. A gNB-DU 228 is a logical node that hosts the radio link control (RLC), medium access control (MAC), and physical (PHY) layers of the gNB 222. Its operation is controlled by the gNB-CU 226. One gNB-DU 228 can support one or more cells, and one cell is supported by only one gNB-DU 228. Thus, a UE 204 communicates with the gNB-CU 226 via the RRC, SDAP, and PDCP layers and with a gNB-DU 228 via the RLC, MAC, and PHY layers.

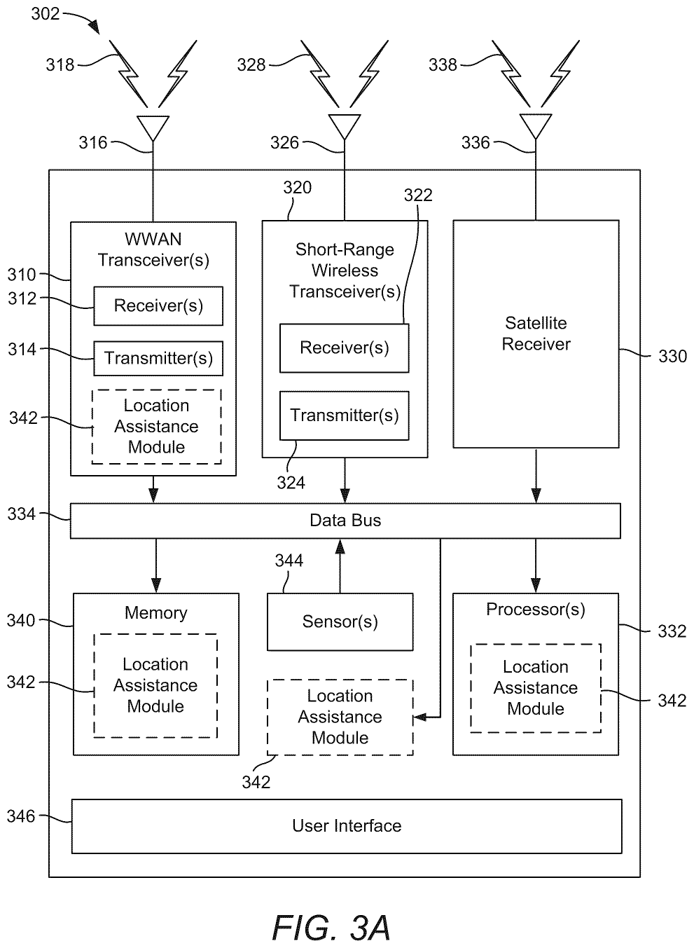

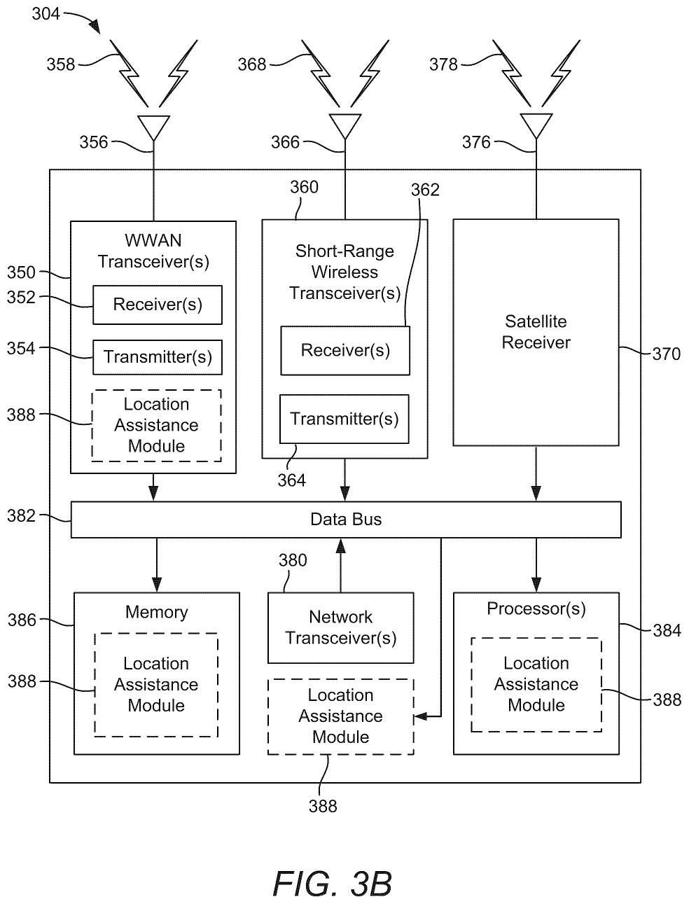

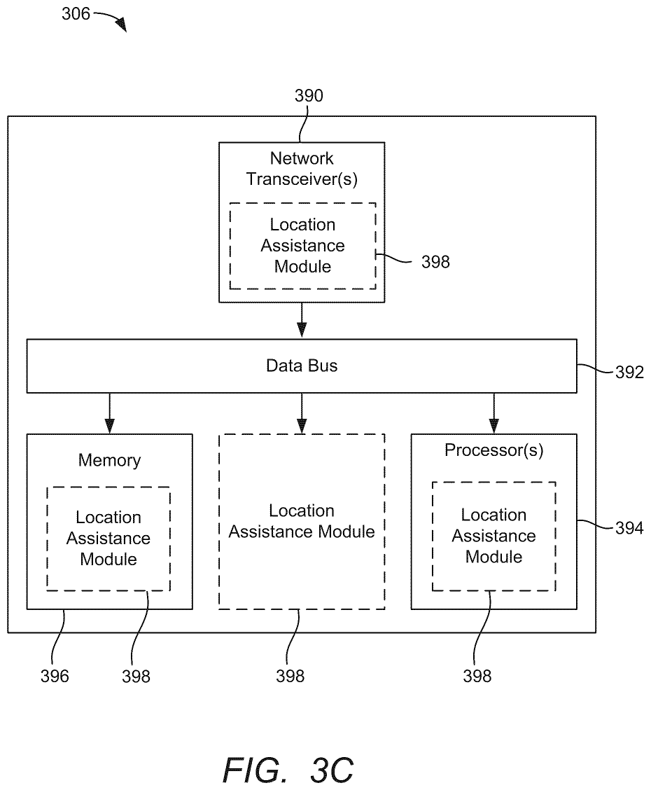

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the file transmission operations as taught herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers. NFC transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include Location Assistance Module 342, 388, and 398, respectively. The Location Assistance Module 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the Location Assistance Module 342, 388, and 398 may be external to the processors 332, 384, and 394 (e.g., part of a modem processing system, integrated with another processing system, etc.). Alternatively, the Location Assistance Module 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the Location Assistance Module 342, which may be, for example, part of the one or more WWAN transceivers 310, the memory 340, the one or more processors 332, or any combination thereof, or may be a standalone component. FIG. 3B illustrates possible locations of the Location Assistance Module 388, which may be, for example, part of the one or more WWAN transceivers 350, the memory 386, the one or more processors 384, or any combination thereof, or may be a standalone component. FIG. 3C illustrates possible locations of the Location Assistance Module 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the uplink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the Location Assistance Module 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. In an OTDOA or DL-TDOA positioning procedure, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity can estimate the UE's location.

For DL-AoD positioning, the positioning entity uses a beam report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE. For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT”). In an RTT procedure, an initiator (a base station or a UE) transmits an RTT measurement signal (e.g., a PRS or SRS) to a responder (a UE or base station), which transmits an RTT response signal (e.g., an SRS or PRS) back to the initiator. The RTT response signal includes the difference between the ToA of the RTT measurement signal and the transmission time of the RTT response signal, referred to as the reception-to-transmission (Rx-Tx) time difference. The initiator calculates the difference between the transmission time of the RTT measurement signal and the ToA of the RTT response signal, referred to as the transmission-to-reception (Tx-Rx) time difference. The propagation time (also referred to as the “time of flight”) between the initiator and the responder can be calculated from the Tx-Rx and Rx-Tx time differences. Based on the propagation time and the known speed of light, the distance between the initiator and the responder can be determined. For multi-RTT positioning, a UE performs an RTT procedure with multiple base stations to enable its location to be determined (e.g., using multilateration) based on the known locations of the base stations. RTT and multi-RTT methods can be combined with other positioning techniques, such as UL-AoA and DL-AoD, to improve location accuracy.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive positioning subframes, periodicity of positioning subframes, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

As noted above, location assistance data may be provided to UEs include identifiers of the base stations (or the cells/TRPs of the base stations) from which to measure reference signals, the reference signal configuration parameters (e.g., the number of consecutive positioning subframes, periodicity of positioning subframes, muting sequence, frequency hopping sequence, reference signal identifier, reference signal bandwidth, etc.), and/or other parameters applicable to a particular positioning method. Such location assistance data is typically provided under the assumption that the target UEs are terrestrial or grounded UEs (i.e., incapable of flight).

A new class of UE is referred to as an aerial UE or unmanned aerial vehicle (UAV). Aerial UAVs may, from time to time, engage in an in-flight mode or flying state. In some designs, some components of the network (e.g., serving gNB, etc.) may recognize a UE as an aerial UE or UAV (e.g., to improve communication, for beamforming, etc.). However, the LMF does not have knowledge of the aerial status of UEs.

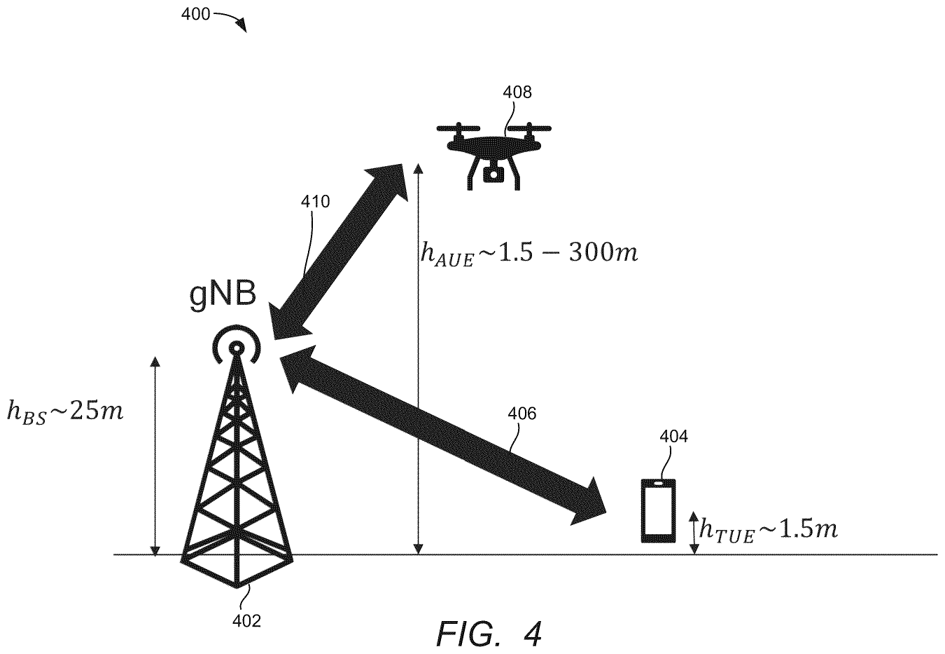

FIG. 4 illustrates a channel model 400 for UAVs in accordance with an aspect of the disclosure. In FIG. 4, gNB 402 communicates with a terrestrial or grounded UE 404 via beam 406, and gNB 402 communicates with an in-flight aerial UE (or UAV) 408 via beam 410. As shown in FIG. 4, the respective antennas of the gNB 402, UE 404 and UE 408 may be at different heights. For example, the antenna height of gNB 402 (has) may be around 25 m, the antenna height of UE 404 (h_{TUE}) may be around 1.5 m, and the antenna height of UE 408 (H_{AUE}) may be anywhere between around 1.5 to 300 m. Also, due to the lack of physical obstructions at higher elevations, the beam 410 is more likely to be LOS than the beam 406. For example, the LOS probability may increase with height. Generally, if H_{AUE}>22 m, the LOS probability may be near 100%.

Aspects of the disclosure are directed to conveying, to a location server (e.g., an LMF), information that is based on the UE being configured as an aerial UE that is capable of flight (e.g., whether UE is aerial UE or UAV, in-flight status or grounded status of UAV, flight path information that indicates a future path of UAV, etc.). In some designs, the location server (e.g., an LMF) may use this information to select assistance data (e.g., location assistance data) that is tailored to UAVs generally and/or is tailored to specific UAVs (e.g., based on flight path, etc.). Such aspects may provide various technical advantages, such as improved positioning for UAVs.

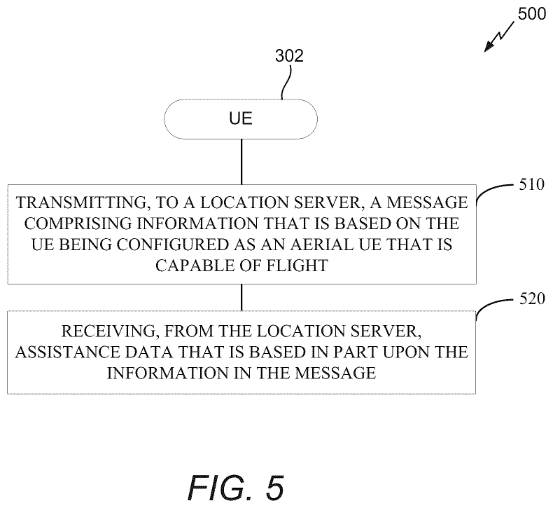

FIG. 5 illustrates an exemplary process 500 of wireless communication, according to aspects of the disclosure. In an aspect, the process 500 may be performed by a UE, such as UE 302. In particular, the UE that performs the process 500 is an aerial UE that is capable of flight, or UAV.

Referring to FIG. 5, at 510, UE 302 (e.g., transmitter 314 or 324, etc.) transmits, to a location server (e.g., LMF integrated in BS 304, or LMF in network entity 306, etc.), a message including information that is based on the UE being configured as an aerial UE that is capable of flight. As will be described in more detail below, the information may indicate whether UE is aerial UE or UAV, in-flight status or grounded status of UAV, flight path information that indicates a future path of UAV, etc. In some designs, a means for performing the transmission of 510 may include transmitter 314 or 324 of UE 302, as described above with respect to FIG. 3A.

Referring to FIG. 5, at 520, UE 302 (e.g., receiver 312 or 322, etc.) receives from the location server (e.g., LMF), assistance data (e.g., location assistance data) that is based in part upon the information in the message. In other words, the information based on the UE being configured as an aerial UE that is capable of flight may be used to tailor or optimize the assistance data (e.g., location assistance data) received at UE 302 at 520. In some designs, a means for performing the reception of 520 may include receiver 312 or 322 of UE 302, as described above with respect to FIG. 3A.

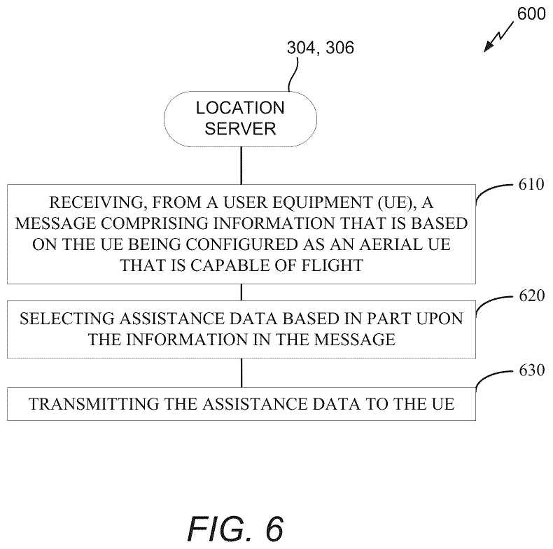

FIG. 6 illustrates an exemplary process 600 of wireless communication, according to aspects of the disclosure. In an aspect, the process 600 may be performed by a location server (e.g., LMF), such as LMF 270 (e.g., which may be integrated in BS 304, or may be integrated in network entity 306 such as core network component or external server, etc.).

Referring to FIG. 6, at 610, the location server (e.g., LMF) (e.g., receiver 352 or 362, network transceiver(s) 380 or 390, etc.) receives from a UE, a message including information that is based on the UE being configured as an aerial UE that is capable of flight. As will be described in more detail below, the information may indicate whether UE is aerial UE or UAV, in-flight status or grounded status of UAV, flight path information that indicates a future path of UAV, etc. In some designs, a means for performing the reception of 610 may include receiver 352 of 362 or network transceiver(s) 380 as described above with respect to FIG. 3B (e.g., in case location server (e.g., LMF) is integrated in BS 304) or may include network transceiver(s) 390 as described above with respect to FIG. 3C (e.g., in case location server (e.g., LMF) is integrated in network entity 306).

Referring to FIG. 6, at 620, the location server (e.g., LMF) (e.g., processor(s) 384 or 394, location assistance module 388 or 398, etc.) selects assistance data (e.g., location assistance data) based in part upon the information in the message. As will be described in more detail below, in some designs, the selection at 620 may select a different configuration of beams, base stations, etc. that is more suitable to aerial UEs than non-aerial or grounded aerial UEs. In some designs, a means for performing the selection of 620 may include processor(s) 384 or location assistance module 388 as described above with respect to FIG. 3B (e.g., in case location server (e.g., LMF) is integrated in BS 304) or may include processor(s) 394 or location assistance module 398 as described above with respect to FIG. 3C (e.g., in case location server (e.g., LMF) is integrated in network entity 306).

Referring to FIG. 6, at 630, the location server (e.g., LMF) (e.g., transmitter 354 or 364, network transceiver(s) 380 or 390, etc.) transmits the assistance data (e.g., location assistance data) to the UE. In some designs, a means for performing the transmission of 630 may include transmitter 354 or 364 or network transceiver(s) 380 as described above with respect to FIG. 3B (e.g., in case location server (e.g., LMF) is integrated in BS 304) or may include network transceiver(s) 390 as described above with respect to FIG. 3C (e.g., in case location server (e.g., LMF) is integrated in network entity 306).

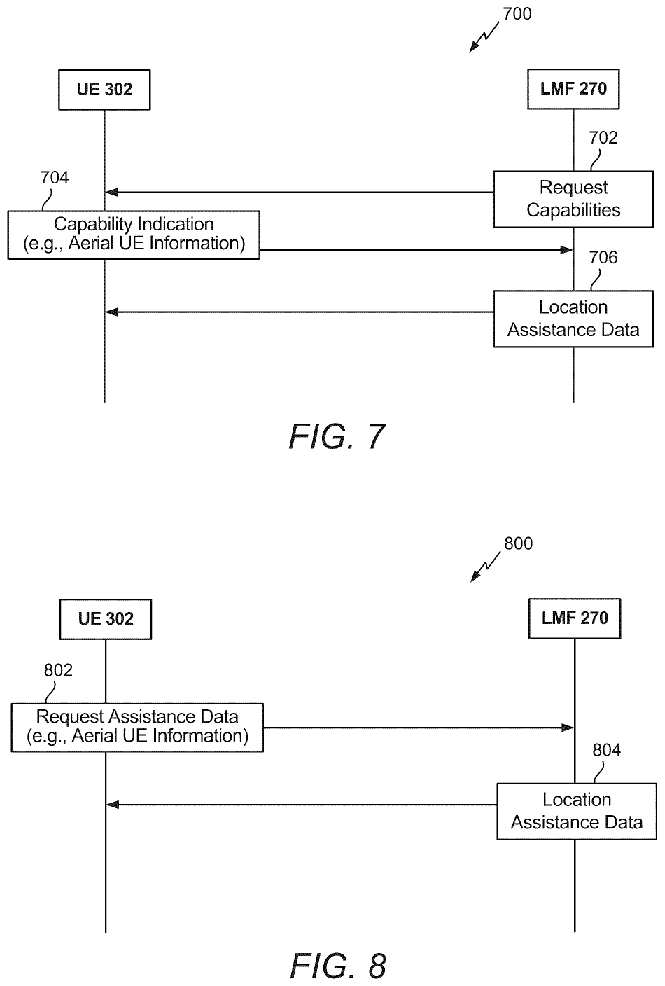

FIG. 7 illustrates an example implementation 700 of the processes 500-600 of FIGS. 5-6 in accordance with an aspect of the disclosure. In FIG. 7, the location server includes LMF 270. At 702, LMF 270 optionally transmits (e.g., because UE information may be sent with or without the request from the location server) a request for capabilities to UE 302. At 704, UE 302 provides information regarding its capabilities to the location server (e.g., transmits a capability indication in response to the request from 702). In particular, the capability indication includes aerial UE information, and corresponds to the message from 510 of FIG. 5 or 610 of FIG. 6. At 706 (e.g., as at 520 of FIG. 5 or 630 of FIG. 6), LMF 270 transmits assistance data (e.g., location assistance data) to UE 302 based on the capability indication from 704. Hence, in FIG. 7, the aerial UE information is sent responsive to a request initiated from the network.

Referring to FIG. 7, in some designs, the request at 702 may request whether the UE is UAV, or may request flight path information, etc. In some designs, the request at 702 may be a modified version of a capability request message. For example, the RequestCapabilities-r9-IEs message may be modified to include a new IE such as, e.g.:

| | |
|---|---|
| nr-requestFlightPath-r18 | NR-requestFlightPath-r18 OPTIONAL |

In other designs, the request at 702 may be included in a new message that is specific to requesting flight path information. In other designs, the request at 702 may be part of request for location information, such as RequestLocationInformation message.

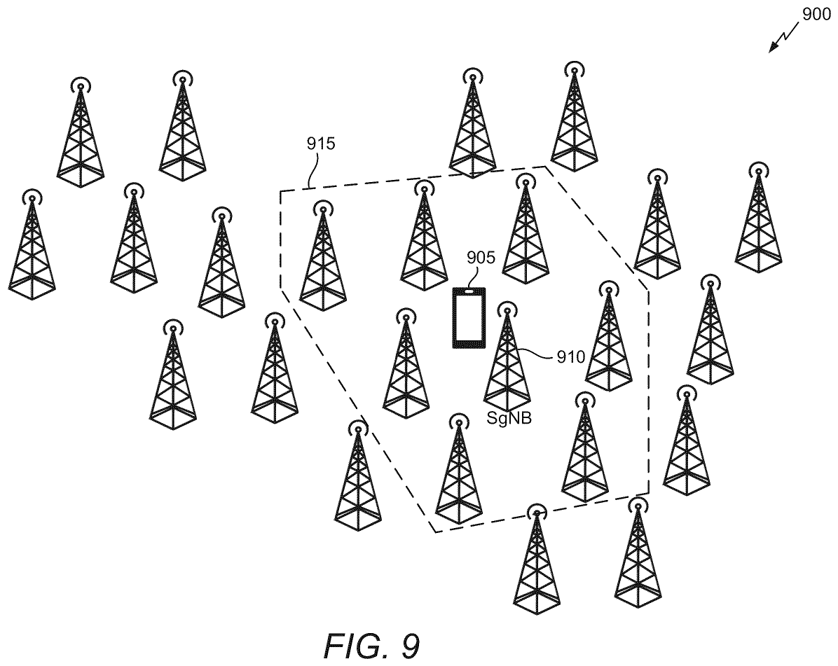

FIG. 8 illustrates an example implementation 800 of the processes 500-600 of FIGS. 5-6 in accordance with another aspect of the disclosure. In FIG. 8, the location server includes LMF 270. At 802, UE 302 transmits a request for assistance data. In particular, the request for assistance data includes aerial UE information, and corresponds to the message from 510 of FIG. 5 or 610 of FIG. 6. At 804 (e.g., as at 520 of FIG. 5 or 630 of FIG. 6), LMF 270 transmits assistance data (e.g., location assistance data) to UE 302 in response to the request from 802. Hence, in FIG. 7, the aerial UE information is sent via a request initiated from UE 302.

Referring to FIGS. 7-8, in some designs, the message that provides the UAV capabilities at 704 of FIG. 7 or 802 of FIG. 8 may correspond to a ProvideCapabilities-r9-IEs message. For example, the ProvideCapabilities-r9-IEs message may be modified to include a new IE such as, e.g.:

| | |
|---|---|
| nr-provideFlightPath-r18 | NR-provideFlightPath-r18 OPTIONAL, |
| nr-provideUAVState-r18 | NR-provideUAVState-r18 OPTIONAL, |

In yet other designs, the information at 510 of FIG. 5 or 610 of FIG. 6 may be signaled via the signaling of location information. For example, the UE may take part in a position estimation procedure (e.g., measure SL and/or DL PRS, transmit SRS-P for measurement by one or more other wireless nodes, etc.), and report (e.g., via LTE Positioning Protocol (LPP), RRC, etc.) location information associated with the position estimation procedure. In this case, the report with the location information may further include the information of 510 or 610 (e.g., aerial UE or UAV-related information can be piggybacked onto a location measurement report).

Referring to FIGS. 5-6, in some designs, the information in the message at 510 of FIG. 5 or 610 of FIG. 6 may indicate that the UE is configured as the aerial UE (e.g., single bit indication that indicates either aerial UE or non-aerial UE). In some designs, the information in the message at 510 of FIG. 5 or 610 of FIG. 6 may indicate whether the UE is engaged in a flying state or a ground state (e.g., one bit to indicate aerial UE vs. non-aerial UE, and another bit to indicate grounded state vs. flying state in case of aerial UE). In some designs, in case of an aerial UE in a flying state, supplemental information related to the flying state of the aerial UE may be indicated, such as a height or altitude of the UE.

Referring to FIGS. 5-6, in some designs, the information in the message at 510 of FIG. 5 or 610 of FIG. 6 may include flight path information. In some designs, the flight path information may include a sequence of waypoints and associated time stamps, similar to 3GPP Rel. 15 LTE RRC, e.g.:

| | |
|---|---|
| FlightPathInfoReport-r15 ::= | SEQUENCE { |
| * flightPath-r15 | SEQUENCE (SIZE(1..maxWayPoint-r15)) OF |
| WayPointLocation-r15 | OPTIONAL, |
| * nonCriticalExtension | SEQUENCE { } OPTIONAL |

}

| | |
|---|---|
| WayPointLocation-r15 ::= | SEQUENCE { |
| wayPointLocation-r15 | LocationInfo-r10, |
| * timeStamp-r15 | Absolute TimeInfo-r10 OPTIONAL |

}

In some designs, the sequence of waypoints corresponds to a sequence of points, coordinates, polygons, polyhedrons or ellipsoids. Accordingly, the waypoints may be “volumes” instead of areas or discrete points or coordinates. One example of an ellipsoidal waypoint configuration is as follows:

| | |
|---|---|
| LocationInfo-r10 ::= | SEQUENCE { |
| locationCoordinates-r10 | CHOICE { |
| ellipsoid-Point-r10 | OCTET STRING |

(CONTAINING Ellipsoid-Point),

| | |
|---|---|
| ellipsoidPointWithAltitude-r10 | OCTET STRING |

(CONTAINING EllipsoidPointWithAltitude),
--... ...,

| | |
|---|---|
| ellipsoidPointWithUncertaintyCircle-r11 | OCTET STRING |

(CONTAINING Ellipsoid-PointWithUncertaintyCircle),

| | |
|---|---|
| ellipsoidPointWithUncertaintyEllipse-r11 | OCTET STRING |

(CONTAINING EllipsoidPointWithUncertaintyEllipse),

| | |
|---|---|
| ellipsoidPointWithAltitudeAndUncertaintyEllipsoid-r11 | OCTET STRING |

(CONTAINING EllipsoidPointWithAltitudeAndUncertaintyEllipsoid),

| | |
|---|---|
| ellipsoidArc-r11 | OCTET STRING |

(CONTAINING EllipsoidArc),

| | |
|---|---|
| polygon-r11 | OCTET STRING (CONTAINING |

Polygon)
},

| | |
|---|---|
| * horizontalVelocity-r10 | OCTET STRING (CONTAINING |
| HorizontalVelocity) | OPTIONAL, |
| * gnss-TOD-msec-r10 | OCTET STRING (CONTAINING Gnss-TOD- |

```
msec) OPTIONAL,
      ...
  }
```

Referring to FIGS. 5-6, in some designs, the flight path information comprises a trajectory and velocity of the UE. This can be indicated in a variety of ways, such as two coordinates (e.g., current and future) and associated time stamps, or a direction/orientation indication along with a speed indication, etc.

Referring to FIGS. 5-6, in some designs, the selection of nodes to participate in a positioning session may depend on the status of the UE. For example, for a terrestrial UE, it typically is not beneficial to signal nodes that are very far away from the serving gNB. However, UAVs (especially high-flying UAVs), may connect to gNBs very far away, and thus there is a need to adjust the assistance data accordingly.

FIG. 9 illustrates a communications system 900 in accordance with an aspect of the disclosure. In FIG. 9, various base stations are deployed in the communications system 900. A grounded aerial UAV or non-aerial UE 905 is served by a serving gNB 910. In this case, assistance data (e.g., location assistance data) may be sent to UE 905 with a clustered base station grouping 915. In other words, the clustered base station grouping 915 is representative of the nodes that are reference in the assistance data (e.g., location assistance data). In the case of a grounded aerial UAV or non-aerial UE, it will be appreciated that the clustered base station grouping 915 generally includes the closest gNBs to UE 905, rather than “remote” gNBs where intervening gNBs are omitted from the clustered base station grouping 915.

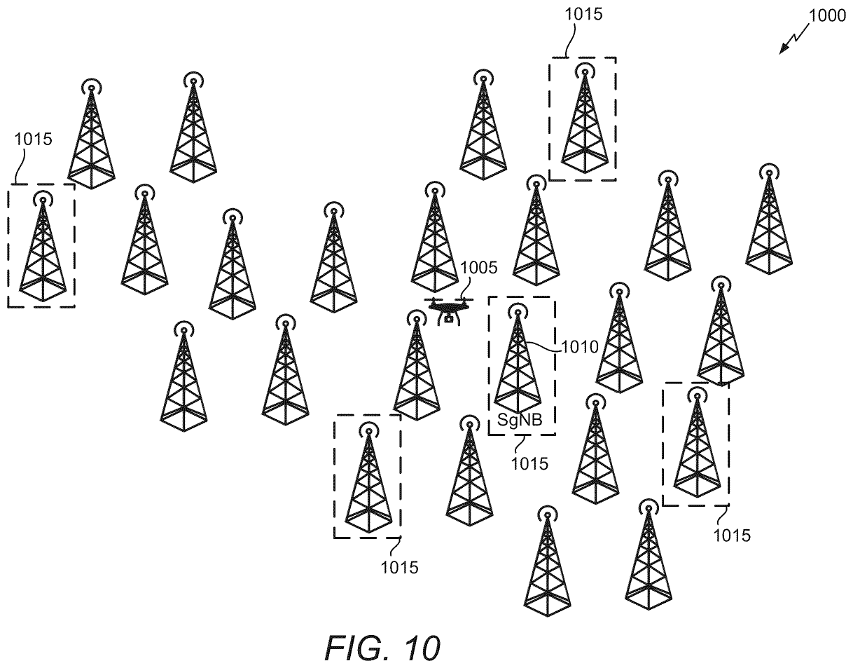

FIG. 10 illustrates a communications system 1000 in accordance with an aspect of the disclosure. In FIG. 10, various base stations are deployed in the communications system 900. An in-flight aerial UE 1005 is served by a serving gNB 1010. In this case, assistance data (e.g., location assistance data) may be sent to UE 1005 with a distributed base station grouping 1015. In other words, the distributed base station grouping 1015 is representative of the nodes that are reference in the assistance data (e.g., location assistance data). In the case of an aerial UE, it will be appreciated that the distributed base station grouping 1015 generally may include remote gNBs due to the higher availability of LOS links (and hence higher communicative range) for connections between the UE 1005 and the gNBs of the communications system 1000. Accordingly, the assistance data (e.g., location assistance data) at 520 of FIG. 5 or 620-630 of FIG. 6 may include information associated with one or more base stations that are remote from the UE, with one or more other intervening base stations that are closer to the UE being omitted from the assistance data (e.g., location assistance data), as in FIG. 10.

Referring to FIGS. 5-6, in some designs, the assistance data (e.g., location assistance data) includes information associated with one or more beams from one or more base stations that are angled upwards to facilitate communication with in-flight aerial UEs (e.g., as shown in FIG. 4).

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an insulator and a conductor). Furthermore, it is also intended that aspects of a clause can be included in any other independent clause, even if the clause is not directly dependent on the independent clause.

Implementation examples are described in the following numbered clauses:
Clause 1. A method of operating a user equipment (UE), comprising: transmitting, to a location server, a message comprising information that is based on the UE being configured as an aerial UE that is capable of flight; and receiving, from the location server, assistance data that is based in part upon the information in the message.
Clause 2. The method of clause 1, further comprising: receiving a capability request from the location server, wherein the message is transmitted in response to the capability request.
Clause 3. The method of any of clauses 1 to 2, wherein the message corresponds to a request for the assistance data.
Clause 4. The method of any of clauses 1 to 3, wherein the message corresponds to a capability indication.
Clause 5. The method of any of clauses 1 to 4, wherein the information indicates that the UE is configured as the aerial UE.
Clause 6. The method of any of clauses 1 to 5, wherein the information indicates whether the UE is engaged in a flying state or a ground state.
Clause 7. The method of clause 6, wherein the information indicates that the UE is engaged in the flying state, and wherein the information further indicates a height or altitude of the UE.
Clause 8. The method of any of clauses 1 to 7, wherein the information comprises flight path information.
Clause 9. The method of clause 8, wherein the flight path information comprises a sequence of waypoints and associated time stamps.
Clause 10. The method of clause 9, wherein the sequence of waypoints corresponds to a sequence of points, coordinates, polygons, or ellipsoids.
Clause 11. The method of any of clauses 8 to 10, wherein the flight path information comprises a trajectory and velocity of the UE.
Clause 12. The method of any of clauses 1 to 11, wherein the assistance data comprises information associated with one or more beams from one or more base stations that are angled upwards to facilitate communication with in-flight aerial UEs.
Clause 13. The method of any of clauses 1 to 12, wherein the assistance data comprises information associated with one or more base stations that are remote from the UE, with one or more other intervening base stations that are closer to the UE being omitted from the assistance data.
Clause 14. The method of any of clauses 1 to 13, wherein the network entity comprises a location management function (LMF).
Clause 15. A method of operating a location server, comprising: receiving, from a user equipment (UE), a message comprising information that is based on the UE being configured as an aerial UE that is capable of flight; selecting assistance data based in part upon the information in the message; and transmitting the assistance data to the UE.
Clause 16. The method of clause 15, further comprising: transmitting a capability request to the UE, wherein the message is received in response to the capability request.
Clause 17. The method of any of clauses 15 to 16, wherein the message corresponds to a request for the assistance data.
Clause 18. The method of any of clauses 15 to 17, wherein the message corresponds to a capability indication.
Clause 19. The method of any of clauses 15 to 18, wherein the information indicates that the UE is configured as the aerial UE.
Clause 20. The method of any of clauses 15 to 19, wherein the information indicates whether the UE is engaged in a flying state or a ground state.
Clause 21. The method of clause 20, wherein the information indicates that the UE is engaged in the flying state, and wherein the information further indicates a height or altitude of the UE.
Clause 22. The method of any of clauses 15 to 21, wherein the information comprises flight path information.
Clause 23. The method of clause 22, wherein the flight path information comprises a sequence of waypoints and associated time stamps.
Clause 24. The method of clause 23, wherein the sequence of waypoints corresponds to a sequence of points, coordinates, polygons, or ellipsoids.
Clause 25. The method of any of clauses 22 to 24, wherein the flight path information comprises a trajectory and velocity of the UE.
Clause 26. The method of any of clauses 15 to 25, wherein the assistance data comprises information associated with one or more beams from one or more base stations that are angled upwards to facilitate communication with in-flight aerial UEs.
Clause 27. The method of any of clauses 15 to 26, wherein the assistance data comprises information associated with one or more base stations that are remote from the UE, with one or more other intervening base stations that are closer to the UE being omitted from the assistance data.
Clause 28. The method of any of clauses 15 to 27, wherein the network entity comprises a location management function (LMF).
Clause 29. A user equipment (UE), comprising: a memory; at least one transceiver; and at least one processor communicatively coupled to the memory and the at least one transceiver, the at least one processor configured to: transmit, via the at least one transceiver, to a location server, a message comprising information that is based on the UE being configured as an aerial UE that is capable of flight; and receive, via the at least one transceiver, from the location server, assistance data that is based in part upon the information in the message.
Clause 30. The UE of clause 29, wherein the at least one processor is further configured to: receive, via the at least one transceiver, a capability request from the location server, wherein the message is transmitted in response to the capability request.
Clause 31. The UE of any of clauses 29 to 30, wherein the message corresponds to a request for the assistance data.
Clause 32. The UE of any of clauses 29 to 31, wherein the message corresponds to a capability indication.
Clause 33. The UE of any of clauses 29 to 32, wherein the information indicates that the UE is configured as the aerial UE.
Clause 34. The UE of any of clauses 29 to 33, wherein the information indicates whether the UE is engaged in a flying state or a ground state.
Clause 35. The UE of clause 34, wherein the information indicates that the UE is engaged in the flying state, and wherein the information further indicates a height or altitude of the UE.
Clause 36. The UE of any of clauses 29 to 35, wherein the information comprises flight path information.
Clause 37. The UE of clause 36, wherein the flight path information comprises a sequence of waypoints and associated time stamps.
Clause 38. The UE of clause 37, wherein the sequence of waypoints corresponds to a sequence of points, coordinates, polygons, or ellipsoids.
Clause 39. The UE of any of clauses 36 to 38, wherein the flight path information comprises a trajectory and velocity of the UE.
Clause 40. The UE of any of clauses 29 to 39, wherein the assistance data comprises information associated with one or more beams from one or more base stations that are angled upwards to facilitate communication with in-flight aerial UEs.
Clause 41. The UE of any of clauses 29 to 40, wherein the assistance data comprises information associated with one or more base stations that are remote from the UE, with one or more other intervening base stations that are closer to the UE being omitted from the assistance data.
Clause 42. The UE of any of clauses 29 to 41, wherein the network entity comprises a location management function (LMF).
Clause 43. A location server, comprising: a memory; at least one transceiver; and at least one processor communicatively coupled to the memory and the at least one transceiver, the at least one processor configured to: receive, via the at least one transceiver, from a user equipment (UE), a message comprising information that is based on the UE being configured as an aerial UE that is capable of flight; select assistance data based in part upon the information in the message; and transmit, via the at least one transceiver, the assistance data to the UE.
Clause 44. The location server of clause 43, wherein the at least one processor is further configured to: transmit, via the at least one transceiver, a capability request to the UE, wherein the message is received in response to the capability request.
Clause 45. The location server of any of clauses 43 to 44, wherein the message corresponds to a request for the assistance data.
Clause 46. The location server of any of clauses 43 to 45, wherein the message corresponds to a capability indication.
Clause 47. The location server of any of clauses 43 to 46, wherein the information indicates that the UE is configured as the aerial UE.
Clause 48. The location server of any of clauses 43 to 47, wherein the information indicates whether the UE is engaged in a flying state or a ground state.
Clause 49. The location server of clause 48, wherein the information indicates that the UE is engaged in the flying state, and wherein the information further indicates a height or altitude of the UE.
Clause 50. The location server of any of clauses 43 to 49, wherein the information comprises flight path information.
Clause 51. The location server of clause 50, wherein the flight path information comprises a sequence of waypoints and associated time stamps.
Clause 52. The location server of clause 51, wherein the sequence of waypoints corresponds to a sequence of points, coordinates, polygons, or ellipsoids.
Clause 53. The location server of any of clauses 50 to 52, wherein the flight path information comprises a trajectory and velocity of the UE.
Clause 54. The location server of any of clauses 43 to 53, wherein the assistance data comprises information associated with one or more beams from one or more base stations that are angled upwards to facilitate communication with in-flight aerial UEs.
Clause 55. The location server of any of clauses 43 to 54, wherein the assistance data comprises information associated with one or more base stations that are remote from the UE, with one or more other intervening base stations that are closer to the UE being omitted from the assistance data.
Clause 56. The location server of any of clauses 43 to 55, wherein the network entity comprises a location management function (LMF).
Clause 57. A user equipment (UE), comprising: means for transmitting, to a location server, a message comprising information that is based on the UE being configured as an aerial UE that is capable of flight; and means for receiving, from the location server, assistance data that is based in part upon the information in the message.
Clause 58. The UE of clause 57, further comprising: means for receiving a capability request from the location server, wherein the message is transmitted in response to the capability request.
Clause 59. The UE of any of clauses 57 to 58, wherein the message corresponds to a request for the assistance data.
Clause 60. The UE of any of clauses 57 to 59, wherein the message corresponds to a capability indication.
Clause 61. The UE of any of clauses 57 to 60, wherein the information indicates that the UE is configured as the aerial UE.
Clause 62. The UE of any of clauses 57 to 61, wherein the information indicates whether the UE is engaged in a flying state or a ground state.
Clause 63. The UE of clause 62, wherein the information indicates that the UE is engaged in the flying state, and wherein the information further indicates a height or altitude of the UE.
Clause 64. The UE of any of clauses 57 to 63, wherein the information comprises flight path information.
Clause 65. The UE of clause 64, wherein the flight path information comprises a sequence of waypoints and associated time stamps.
Clause 66. The UE of clause 65, wherein the sequence of waypoints corresponds to a sequence of points, coordinates, polygons, or ellipsoids.
Clause 67. The UE of any of clauses 64 to 66, wherein the flight path information comprises a trajectory and velocity of the UE.
Clause 68. The UE of any of clauses 57 to 67, wherein the assistance data comprises information associated with one or more beams from one or more base stations that are angled upwards to facilitate communication with in-flight aerial UEs.
Clause 69. The UE of any of clauses 57 to 68, wherein the assistance data comprises information associated with one or more base stations that are remote from the UE, with one or more other intervening base stations that are closer to the UE being omitted from the assistance data.
Clause 70. The UE of any of clauses 57 to 69, wherein the network entity comprises a location management function (LMF).
Clause 71. A location server, comprising: means for receiving, from a user equipment (UE), a message comprising information that is based on the UE being configured as an aerial UE that is capable of flight; means for selecting assistance data based in part upon the information in the message; and means for transmitting the assistance data to the UE.
Clause 72. The location server of clause 71, further comprising: means for transmitting a capability request to the UE, wherein the message is received in response to the capability request.
Clause 73. The location server of any of clauses 71 to 72, wherein the message corresponds to a request for the assistance data.
Clause 74. The location server of any of clauses 71 to 73, wherein the message corresponds to a capability indication.
Clause 75. The location server of any of clauses 71 to 74, wherein the information indicates that the UE is configured as the aerial UE.
Clause 76. The location server of any of clauses 71 to 75, wherein the information indicates whether the UE is engaged in a flying state or a ground state.
Clause 77. The location server of clause 76, wherein the information indicates that the UE is engaged in the flying state, and wherein the information further indicates a height or altitude of the UE.
Clause 78. The location server of any of clauses 71 to 77, wherein the information comprises flight path information.
Clause 79. The location server of clause 78, wherein the flight path information comprises a sequence of waypoints and associated time stamps.
Clause 80. The location server of clause 79, wherein the sequence of waypoints corresponds to a sequence of points, coordinates, polygons, or ellipsoids.
Clause 81. The location server of any of clauses 78 to 80, wherein the flight path information comprises a trajectory and velocity of the UE.
Clause 82. The location server of any of clauses 71 to 81, wherein the assistance data comprises information associated with one or more beams from one or more base stations that are angled upwards to facilitate communication with in-flight aerial UEs.
Clause 83. The location server of any of clauses 71 to 82, wherein the assistance data comprises information associated with one or more base stations that are remote from the UE, with one or more other intervening base stations that are closer to the UE being omitted from the assistance data.
Clause 84. The location server of any of clauses 71 to 83, wherein the network entity comprises a location management function (LMF).
Clause 85. A non-transitory computer-readable medium storing computer-executable instructions that, when executed by a user equipment (UE), cause the UE to: transmit, to a location server, a message comprising information that is based on the UE being configured as an aerial UE that is capable of flight; and receive, from the location server, assistance data that is based in part upon the information in the message.
Clause 86. The non-transitory computer-readable medium of clause 85, wherein the one or more instructions further cause the UE to: receive a capability request from the location server, wherein the message is transmitted in response to the capability request.
Clause 87. The non-transitory computer-readable medium of any of clauses 85 to 86, wherein the message corresponds to a request for the assistance data.
Clause 88. The non-transitory computer-readable medium of any of clauses 85 to 87, wherein the message corresponds to a capability indication.
Clause 89. The non-transitory computer-readable medium of any of clauses 85 to 88, wherein the information indicates that the UE is configured as the aerial UE.
Clause 90. The non-transitory computer-readable medium of any of clauses 85 to 89, wherein the information indicates whether the UE is engaged in a flying state or a ground state.
Clause 91. The non-transitory computer-readable medium of clause 90, wherein the information indicates that the UE is engaged in the flying state, and wherein the information further indicates a height or altitude of the UE.
Clause 92. The non-transitory computer-readable medium of any of clauses 85 to 91, wherein the information comprises flight path information.
Clause 93. The non-transitory computer-readable medium of clause 92, wherein the flight path information comprises a sequence of waypoints and associated time stamps.
Clause 94. The non-transitory computer-readable medium of clause 93, wherein the sequence of waypoints corresponds to a sequence of points, coordinates, polygons, or ellipsoids.
Clause 95. The non-transitory computer-readable medium of any of clauses 92 to 94, wherein the flight path information comprises a trajectory and velocity of the UE.
Clause 96. The non-transitory computer-readable medium of any of clauses 85 to 95, wherein the assistance data comprises information associated with one or more beams from one or more base stations that are angled upwards to facilitate communication with in-flight aerial UEs.
Clause 97. The non-transitory computer-readable medium of any of clauses 85 to 96, wherein the assistance data comprises information associated with one or more base stations that are remote from the UE, with one or more other intervening base stations that are closer to the UE being omitted from the assistance data.
Clause 98. The non-transitory computer-readable medium of any of clauses 85 to 97, wherein the network entity comprises a location management function (LMF).
Clause 99. A non-transitory computer-readable medium storing computer-executable instructions that, when executed by a location server, cause the location server to: receive, from a user equipment (UE), a message comprising information that is based on the UE being configured as an aerial UE that is capable of flight; select assistance data based in part upon the information in the message; and transmit the assistance data to the UE.
Clause 100. The non-transitory computer-readable medium of clause 99, wherein the one or more instructions further cause the location server to: transmit a capability request to the UE, wherein the message is received in response to the capability request.
Clause 101. The non-transitory computer-readable medium of any of clauses 99 to 100, wherein the message corresponds to a request for the assistance data.
Clause 102. The non-transitory computer-readable medium of any of clauses 99 to 101, wherein the message corresponds to a capability indication.
Clause 103. The non-transitory computer-readable medium of any of clauses 99 to 102, wherein the information indicates that the UE is configured as the aerial UE.
Clause 104. The non-transitory computer-readable medium of any of clauses 99 to 103, wherein the information indicates whether the UE is engaged in a flying state or a ground state.
Clause 105. The non-transitory computer-readable medium of clause 104, wherein the information indicates that the UE is engaged in the flying state, and wherein the information further indicates a height or altitude of the UE.
Clause 106. The non-transitory computer-readable medium of any of clauses 99 to 105, wherein the information comprises flight path information.
Clause 107. The non-transitory computer-readable medium of clause 106, wherein the flight path information comprises a sequence of waypoints and associated time stamps.
Clause 108. The non-transitory computer-readable medium of clause 107, wherein the sequence of waypoints corresponds to a sequence of points, coordinates, polygons, or ellipsoids.
Clause 109. The non-transitory computer-readable medium of any of clauses 106 to 108, wherein the flight path information comprises a trajectory and velocity of the UE.
Clause 110. The non-transitory computer-readable medium of any of clauses 99 to 109, wherein the assistance data comprises information associated with one or more beams from one or more base stations that are angled upwards to facilitate communication with in-flight aerial UEs.
Clause 111. The non-transitory computer-readable medium of any of clauses 99 to 110, wherein the assistance data comprises information associated with one or more base stations that are remote from the UE, with one or more other intervening base stations that are closer to the UE being omitted from the assistance data.
Clause 112. The non-transitory computer-readable medium of any of clauses 99 to 111, wherein the network entity comprises a location management function (LMF).

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of operating a user equipment (UE), comprising:
transmitting, to a location server, a message comprising information that is based on the UE being configured as an aerial UE that is capable of flight; and
receiving, from the location server, assistance data that is based in part upon the information in the message.

2. The method of claim 1, further comprising:
receiving a capability request from the location server,
wherein the message is transmitted in response to the capability request.

3. The method of claim 1, wherein the message corresponds to a request for the assistance data.

4. The method of claim 1, wherein the message corresponds to a capability indication.

5. The method of claim 1, wherein the information indicates that the UE is configured as the aerial UE.

6. The method of claim 1, wherein the information indicates whether the UE is engaged in a flying state or a ground state.

7. The method of claim 6,
wherein the information indicates that the UE is engaged in the flying state, and
wherein the information further indicates a height or altitude of the UE.

8. The method of claim 1, wherein the information comprises flight path information.

9. The method of claim 8, wherein the flight path information comprises a sequence of waypoints and associated time stamps.

10. The method of claim 9, wherein the sequence of waypoints corresponds to a sequence of points, coordinates, polygons, or ellipsoids.

11. The method of claim 8, wherein the flight path information comprises a trajectory and velocity of the UE.

12. The method of claim 1, wherein the assistance data comprises information associated with one or more beams from one or more base stations that are angled upwards to facilitate communication with in-flight aerial UEs.

13. The method of claim 1, wherein the assistance data comprises information associated with one or more base stations that are remote from the UE, with one or more other intervening base stations that are closer to the UE being omitted from the assistance data.

14. The method of claim 1, wherein the network entity comprises a location management function (LMF).

15. A method of operating a location server, comprising:
receiving, from a user equipment (UE), a message comprising information that is based on the UE being configured as an aerial UE that is capable of flight;
selecting assistance data based in part upon the information in the message; and
transmitting the assistance data to the UE.

16. The method of claim 15, further comprising:
transmitting a capability request to the UE,
wherein the message is received in response to the capability request.

17. The method of claim 15, wherein the message corresponds to a request for the assistance data.

18. The method of claim 15, wherein the message corresponds to a capability indication.

19. The method of claim 15, wherein the information indicates that the UE is configured as the aerial UE.

20. The method of claim 15, wherein the information indicates whether the UE is engaged in a flying state or a ground state.

21. The method of claim 20,
wherein the information indicates that the UE is engaged in the flying state, and
wherein the information further indicates a height or altitude of the UE.

22. The method of claim 15, wherein the information comprises flight path information.

23. The method of claim 22, wherein the flight path information comprises a sequence of waypoints and associated time stamps.

24. The method of claim 23, wherein the sequence of waypoints corresponds to a sequence of points, coordinates, polygons, or ellipsoids.

25. The method of claim 22, wherein the flight path information comprises a trajectory and velocity of the UE.

26. The method of claim 15, wherein the assistance data comprises information associated with one or more beams from one or more base stations that are angled upwards to facilitate communication with in-flight aerial UEs.

27. The method of claim 15, wherein the assistance data comprises information associated with one or more base stations that are remote from the UE, with one or more other intervening base stations that are closer to the UE being omitted from the assistance data.

28. The Method of claim 15, wherein the network entity comprises a location management function (LMF).

29. A user equipment (UE), comprising:
a memory;
at least one transceiver; and
at least one processor communicatively coupled to the memory and the at least one transceiver, the at least one processor configured to:
transmit, via the at least one transceiver, to a location server, a message comprising information that is based on the UE being configured as an aerial UE that is capable of flight; and
receive, via the at least one transceiver, from the location server, assistance data that is based in part upon the information in the message.

30. The UE of claim 29, wherein the at least one processor is further configured to:
receive, via the at least one transceiver, a capability request from the location server,
wherein the message is transmitted in response to the capability request.

31. The UE of claim 29, wherein the message corresponds to a request for the assistance data.

32. The UE of claim 29, wherein the message corresponds to a capability indication.

33. The UE of claim 29, wherein the information indicates that the UE is configured as the aerial UE.

34. The UE of claim 29, wherein the information indicates whether the UE is engaged in a flying state or a ground state.

35. The UE of claim 34,
wherein the information indicates that the UE is engaged in the flying state, and
wherein the information further indicates a height or altitude of the UE.

36. The UE of claim 29, wherein the information comprises flight path information.

37. The UE of claim 36, wherein the flight path information comprises a sequence of waypoints and associated time stamps.

38. The UE of claim 37, wherein the sequence of waypoints corresponds to a sequence of points, coordinates, polygons, or ellipsoids.

39. The UE of claim 36, wherein the flight path information comprises a trajectory and velocity of the UE.

40. The UE of claim 29, wherein the assistance data comprises information associated with one or more beams from one or more base stations that are angled upwards to facilitate communication with in-flight aerial UEs.

41. The UE of claim 29, wherein the assistance data comprises information associated with one or more base stations that are remote from the UE, with one or more other intervening base stations that are closer to the UE being omitted from the assistance data.

42. The UE of claim 29, wherein the network entity comprises a location management function (LMF).

43. A location server, comprising:
a memory;
at least one transceiver; and
at least one processor communicatively coupled to the memory and the at least one transceiver, the at least one processor configured to:
receive, via the at least one transceiver, from a user equipment (UE), a message comprising information that is based on the UE being configured as an aerial UE that is capable of flight;
select assistance data based in part upon the information in the message; and
transmit, via the at least one transceiver, the assistance data to the UE.

44. The location server of claim 43, wherein the at least one processor is further configured to:
transmit, via the at least one transceiver, a capability request to the UE,
wherein the message is received in response to the capability request.

45. The location server of claim 43, wherein the message corresponds to a request for the assistance data.

46. The location server of claim 43, wherein the message corresponds to a capability indication.

47. The location server of claim 43, wherein the information indicates that the UE is configured as the aerial UE.

48. The location server of claim 43, wherein the information indicates whether the UE is engaged in a flying state or a ground state.

49. The location server of claim 48,
wherein the information indicates that the UE is engaged in the flying state, and
wherein the information further indicates a height or altitude of the UE.

50. The location server of claim 43, wherein the information comprises flight path information.

51. The location server of claim 50, wherein the flight path information comprises a sequence of waypoints and associated time stamps.

52. The location server of claim 51, wherein the sequence of waypoints corresponds to a sequence of points, coordinates, polygons, or ellipsoids.

53. The location server of claim 50, wherein the flight path information comprises a trajectory and velocity of the UE.

54. The location server of claim 43, wherein the assistance data comprises information associated with one or more beams from one or more base stations that are angled upwards to facilitate communication with in-flight aerial UEs.

55. The location server of claim 43, wherein the assistance data comprises information associated with one or more base stations that are remote from the UE, with one or more other intervening base stations that are closer to the UE being omitted from the assistance data.

56. The location server of claim 43, wherein the network entity comprises a location management function (LMF).

57. A user equipment (JE), comprising:
means for transmitting, to a location server, a message comprising information that is based on the UE being configured as an aerial UE that is capable of flight; and
means for receiving, from the location server, assistance data that is based in part upon the information in the message.

58. The UE of claim 57, further comprising:
means for receiving a capability request from the location server,
wherein the message is transmitted in response to the capability request.

59. The UE of claim 57, wherein the message corresponds to a request for the assistance data.

60. The UE of claim 57, wherein the message corresponds to a capability indication.

61. The UE of claim 57, wherein the information indicates that the UE is configured as the aerial UE.

62. The UE of claim 57, wherein the information indicates whether the UE is engaged in a flying state or a ground state.

63. The UE of claim 62,
wherein the information indicates that the UE is engaged in the flying state, and
wherein the information further indicates a height or altitude of the UE.

64. The UE of claim 57, wherein the information comprises flight path information.

65. The UE of claim 64, wherein the flight path information comprises a sequence of waypoints and associated time stamps.

66. The UE of claim 65, wherein the sequence of waypoints corresponds to a sequence of points, coordinates, polygons, or ellipsoids.

67. The UE of claim 64, wherein the flight path information comprises a trajectory and velocity of the UE.

68. The UE of claim 57, wherein the assistance data comprises information associated with one or more beams from one or more base stations that are angled upwards to facilitate communication with in-flight aerial UEs.

69. The IE of claim 57, wherein the assistance data comprises information associated with one or more base stations that are remote from the UE, with one or more other intervening base stations that are closer to the UE being omitted from the assistance data.

70. The UE of claim 57, wherein the network entity comprises a location management function (LMF).

71. A location server, comprising:
means for receiving, from a user equipment (UE), a message comprising information that is based on the UE being configured as an aerial UE that is capable of flight;
means for selecting assistance data based in part upon the information in the message; and
means for transmitting the assistance data to the UE.

72. The location server of claim 71, further comprising:
means for transmitting a capability request to the UE,
wherein the message is received in response to the capability request.

73. The location server of claim 71, wherein the message corresponds to a request for the assistance data.

74. The location server of claim 71, wherein the message corresponds to a capability indication.

75. The location server of claim 71, wherein the information indicates that the UE is configured as the aerial UE.

76. The location server of claim 71, wherein the information indicates whether the UE is engaged in a flying state or a ground state.

77. The location server of claim 76,
wherein the information indicates that the UE is engaged in the flying state, and
wherein the information further indicates a height or altitude of the UE.

78. The location server of claim 71, wherein the information comprises flight path information.

79. The location server of claim 78, wherein the flight path information comprises a sequence of waypoints and associated time stamps.

80. The location server of claim 79, wherein the sequence of waypoints corresponds to a sequence of points, coordinates, polygons, or ellipsoids.

81. The location server of claim 78, wherein the flight path information comprises a trajectory and velocity of the UE.

82. The location server of claim 71, wherein the assistance data comprises information associated with one or more beams from one or more base stations that are angled upwards to facilitate communication with in-flight aerial UEs.

83. The location server of claim 71, wherein the assistance data comprises information associated with one or more base stations that are remote from the UE, with one or more other intervening base stations that are closer to the UE being omitted from the assistance data.

84. The location server of claim 71, wherein the network entity comprises a location management function (LMF).

85. A non-transitory computer-readable medium storing computer-executable instructions that, when executed by a user equipment (UE), cause the UE to:
transmit, to a location server, a message comprising information that is based on the UE being configured as an aerial UE that is capable of flight; and
receive, from the location server, assistance data that is based in part upon the information in the message.

86. The non-transitory computer-readable medium of claim 85, wherein the one or more instructions further cause the UE to:
receive a capability request from the location server,
wherein the message is transmitted in response to the capability request.

87. The non-transitory computer-readable medium of claim 85, wherein the message corresponds to a request for the assistance data.

88. The non-transitory computer-readable medium of claim 85, wherein the message corresponds to a capability indication.

89. The non-transitory computer-readable medium of claim 85, wherein the information indicates that the UE is configured as the aerial UE.

90. The non-transitory computer-readable medium of claim 85, wherein the information indicates whether the UE is engaged in a flying state or a ground state.

91. The non-transitory computer-readable medium of claim 90,
wherein the information indicates that the UE is engaged in the flying state, and
wherein the information further indicates a height or altitude of the UE.

92. The non-transitory computer-readable medium of claim 85, wherein the information comprises flight path information.

93. The non-transitory computer-readable medium of claim 92, wherein the flight path information comprises a sequence of waypoints and associated time stamps.

94. The non-transitory computer-readable medium of claim 93, wherein the sequence of waypoints corresponds to a sequence of points, coordinates, polygons, or ellipsoids.

95. The non-transitory computer-readable medium of claim 92, wherein the flight path information comprises a trajectory and velocity of the UE.

96. The non-transitory computer-readable medium of claim 85, wherein the assistance data comprises information associated with one or more beams from one or more base stations that are angled upwards to facilitate communication with in-flight aerial UEs.

97. The non-transitory computer-readable medium of claim 85, wherein the assistance data comprises information associated with one or more base stations that are remote from the UE, with one or more other intervening base stations that are closer to the UE being omitted from the assistance data.

98. The non-transitory computer-readable medium of claim 85, wherein the network entity comprises a location management function (LMF).

99. A non-transitory computer-readable medium storing computer-executable instructions that, when executed by a location server, cause the location server to:
receive, from a user equipment (UE), a message comprising information that is based on the UE being configured as an aerial UE that is capable of flight:
select assistance data based in part upon the information in the message; and
transmit the assistance data to the UE.

100. The non-transitory computer-readable medium of claim 99, wherein the one or more instructions further cause the location server to:
transmit a capability request to the UE,
wherein the message is received in response to the capability request.

101. The non-transitory computer-readable medium of claim 99, wherein the message corresponds to a request for the assistance data.

102. The non-transitory computer-readable medium of claim 99, wherein the message corresponds to a capability indication.

103. The non-transitory computer-readable medium of claim 99, wherein the information indicates that the UE is configured as the aerial UE.

104. The non-transitory computer-readable medium of claim 99, wherein the information indicates whether the UE is engaged in a flying state or a ground state.

105. The non-transitory computer-readable medium of claim 104,
wherein the information indicates that the UE is engaged in the flying state, and
wherein the information further indicates a height or altitude of the UE.

106. The non-transitory computer-readable medium of claim 99, wherein the information comprises flight path information.

107. The non-transitory computer-readable medium of claim 106, wherein the flight path information comprises a sequence of waypoints and associated time stamps.

108. The non-transitory computer-readable medium of claim 107, wherein the sequence of waypoints corresponds to a sequence of points, coordinates, polygons, or ellipsoids.

109. The non-transitory computer-readable medium of claim 106, wherein the flight path information comprises a trajectory and velocity of the UE.

110. The non-transitory computer-readable medium of claim 99, wherein the assistance data comprises information associated with one or more beams from one or more base stations that are angled upwards to facilitate communication with in-flight aerial UEs.

111. The non-transitory computer-readable medium of claim 99, wherein the assistance data comprises information associated with one or more base stations that are remote from the UE, with one or more other intervening base stations that are closer to the UE being omitted from the assistance data.

112. The non-transitory computer-readable medium of claim 99, wherein the network entity comprises a location management function (LMF).
